(19) United States
(12) Patent Application Publication
(10) Pub. No.: US 2013/0197971 A1
(43) Pub. Date: Aug. 1, 2013

(54) MOTOR VEHICLE DEALER ANALYSIS MARKETING SYSTEM AND METHOD WITH AFTERMARKET ACCESSORIES

(71) Applicant: Martin J. Wilke, Oakland Twp, MI (US)

(72) Inventor: Martin J. Wilke, Oakland Twp, MI (US)

(73) Assignee: Martin J Wilke

(21) Appl. No.: 13/565,009

(22) Filed: Aug. 2, 2012

Related U.S. Application Data
(60) Provisional application No. 61/628,430, filed on Oct. 30, 2011.

(51) Int. Cl. G06Q 30/02

(52) U.S. Cl. CPC G06Q 30/0269
USPC 705/7.31

(57) ABSTRACT

The method and system are used for marketing new and used motor vehicles for sale or lease. Initially a target area proximate to the dealer site is identified by reviewing the dealer's existing customer base to see the distance that the customers are from the dealer site. Then, demographic data is used to determine the ranges of household incomes for the overall population in the target area. Next, it is determined the amount that these households allocate for motor vehicles. Then, the makes and models of motor vehicles that are available to the dealer in these price ranges are identified. Once the size of the dealer's showroom and lot are evaluated, a recommendation is made to the dealer of the appropriate blend and price ranges of new and used motor vehicles to market. Aftermarket accessories for any particular vehicle can also be predicted with some degree of certainty.

This application is related to and claims priority to U.S. Provisional Application No. 61/459,999, entitled “Motor Vehicle Dealer Analysis Marketing System and Method with Aftermarket Accessories”, filed on Nov. 11, 2010; to U.S. Provisional Application No. 61/628,430, entitled “Motor Vehicle Dealer Analysis Marketing System and Method with Aftermarket Accessories”, filed on Oct. 30, 2011; and to PCT Application No. PCT/US2011/01895, entitled “Motor Vehicle Dealer Analysis Marketing System and Method with Aftermarket Accessories”, filed on Nov. 14, 2011. The disclosures of these Applications are hereby incorporated by reference into this specification in their entireties.

### FIELD OF THE INVENTION

The present invention relates generally to the marketing of motor vehicles. More particularly, the present invention relates to systems and methods that are useful for marketing and merchandising motor vehicles from dealerships and improving dealership market share of aftermarket accessory.

### BACKGROUND OF THE INVENTION

For many years retail spend has been accurately tracked in every consumer expenditure category. These expenditures have been very constant over the last 60 years in all categories including annual spend for automotive new car purchases. This figure has also remained constant and in fact has not deviated more than +/−0.5% in the last 10 years.

Motor vehicles, including automobiles, cars, SUV's, vans, and light trucks, whether new or used, are typically expensive purchases from the perspective of a potential retail customer. The expensive nature of the purchase tends to make the customer highly involved in the sales process.

Historically, the motor vehicles on display in a dealer's showrooms continue to stock the types of motor vehicles that they have always sold. If their marketing is initially flawed, these errors cannot be corrected by simply restocking motor vehicles sold. Also, such marketing does not take into account the change in demographics within the target area where the dealers reside.

In the Feb. 4, 2012 issue of “Automotive News”, the National Automobile Dealers Association's (NADA) published their long-awaited study of automakers' facility-renovation mandates, concluding that they cost too much, produce uncertain results and matter little to shoppers.

The CEO of the nation's largest dealership group, Mike Jackson, said he doesn't object to manufacturers setting appropriate facility standards and corporate identity guidelines. But in the past few years, he said, automakers have gone too far. “We're no longer talking about putting McDonald's arches on the building,” Jackson said. “We're talking about making every aspect of the business, of the building, of the facility, meet a corporate ID program. Well, that's of questionable customer value, very expensive and very inflexible. Where does it all end?” Jackson also strongly objects to the manufacturers linking compliance with facility standards to the price dealers pay for cars through the use of volume-based incentives. That connection is “what is mind-boggling” and has made the facility issue so controversial and important, Jackson said.

As a search of the prior art reveals, there are numerous systems and methods known for marketing new and used motor vehicles.

U.S. Patent Document No. 20090313121 (Post et al.) discloses a system for marketing vehicles on a dealership lot. An electronic window sticker computer resides at each vehicle on a dealership lot. The electronic window sticker computers communicate with the remainder of the system through an RF network. A book-in process and/or a lot manager process form a VIN record for a vehicle to which an electronic window sticker computer has been assigned. The VIN record includes a robust set of promotion presentation data that are presented at the electronic window sticker computer using a plurality of screens. User inputs are collected at the electronic window sticker computer and routed to the lot manager process.

U.S. Patent Document No. 20090271296 (Romero) discloses a motor vehicle remarketing service. The system in combination with a nationwide alliance of professional car care enterprises for remarketing privately owned motor vehicles. Consumers register with the system. Successfully registered consumers present their motor vehicles at a participating professional car care enterprise for processing into the system. The service is national in its reach while local in its execution, and provides a national platform for green-marketing the benefits of professional car care versus individual car care alternatives.

U.S. Patent Document No. 20090222485 (Wassmann et al.) discloses a framework and method for aggregating a plurality of product information accessed from a plurality of information sources. The framework comprises an aggregation module for receiving the product information, such as vehicle details, and for assigning a unique identifier to each product definition, such as a vehicle advertisement, associated with the product information. The framework includes a classification module for determining at least one classification for each of the product definitions according to a set of predefined classifications, such as vehicle make and model and dealership.

U.S. Patent Document No. 20080306812 (Bowen et. at) discloses a method and system for determining the effectiveness of a dealer's ability to close a sale. The method of measuring the sales performance of a dealer may include determining a propensity to buy score associated with each lead received by a dealer and determining an expected close rate associated with the dealer that may be based on the determined propensity to buy scores. The method may also include determining an effectiveness rate associated with the dealer that may be based on at least the expected close rate and an actual close rate.

U.S. Patent Document No. 20080183633 (Nagelvoort) discloses a method for facilitating sales and management for integrating the sale of an aftermarket product to a customer with the sale of a vehicle to the customer include receiving sales information associated with the sale of the vehicle, where the sales information includes dealer information and vehicle information. An aftermarket product suitable for the customer is identified (based at least in part on the dealer information and the vehicle information). Aftermarket product terms are presented to the dealer, and an indication is received of the customers desire to purchase the aftermarket product and the sale of the aftermarket product is completed.

U.S. Patent Document No. 20060259350 (Ryan et al.) discloses a system for identifying a market by projecting demand and identifying supply. A market for used vehicles is identified for a particular vehicle category. A group of dealers are selected who have a high likelihood of buying units of the products. To identify a market, inventory data is collected from each of a group of dealers within a region on a recurring basis. A dealer profile specifying the business rules for managing the inventory is obtained or produced for each dealer. A supply of products is determined by collecting inventory data from suppliers, such as automobile leasing companies and dealers with surplus inventory. The demand for products is determined by comparison of the dealer profile for each vehicle category to the actual inventory for the corresponding vehicle category or to the sales history for the product.

U.S. Pat. No. 8,005,731 (Wolfe, et al.) discloses a method and system for managing a purchase request in a Data Center system. The Data Center system receives a purchase request from a plurality of potential buyers. The Data Center system provides access to a plurality of remotely located vehicle dealer or dealer groups. The dealer accesses the purchase request and displays its details. The dealer may then assign the handling of the purchase request to a salesperson. The salesperson ascertains a purchase request property such as an immediate buyer, based upon the purchase request property. The Data Center system further contains one or more action response modules which assist the user to act in response to the ascertained purchase request property. Thus, the Data Center system assists the dealership to efficiently act upon a purchase request.

U.S. Pat. No. 7,844,622 (Lackey, et al.) discloses a and method for maintaining a product specification within regional parameters when selecting options. The specification is dependent on the selection of a number of options by a consumer. The method utilizes a computer program which receives from user a location in which said product will be used. After that, the user is allowed to select product options. Information regarding rules and regulations for that particular location is made available from separately identified data files on a server. Options required in that particular locations will be automatically added to the specification. When additional options are selected, the program determines whether the product is still in compliance in the location selected. If the added option results in the specification running afoul of a regional rule or regulation, the user will be notified, and advised as to how the violation can be overcome. Once the user is satisfied with the options, and these options are in compliance, the specification is completed and useful for making an order.

Dealers have not followed basic marketing principals and the products that they showcase do not match the trade area income distribution characteristics within the communities that they serve. While other factors may also be contributing factors to the economic woes of the OEMs, this marketing problem can be easily addressed and resolved.

The aftermarket industry is quite diverse representing some small trim companies to sophisticated systems from companies that may even have an OEM side to their business. The supply chain for the aftermarket for new and used vehicles covers virtually all parts of the vehicles. Aftermarket systems that can be integrated into automobiles, cars, SUV's, vans, and light trucks include everything from deluxe security systems, keyless entry, remote starters, global positioning systems, mirrors, sunroofs, moon-roofs, convertible tops, internal lighting systems, custom consoles and dashes, trim packages, body side moldings, body trim, trim accessories, kit packages, air bags, heated seats, to leather interiors. Customers are increasingly installing aftermarket tire and wheel combinations, exhaust systems, braking systems, performance suspension systems and engine modifications, such as turbo-superchargers which greatly increase engine power output.

The reasons that the aftermarket is relatively small when it comes to purchases on motor vehicles are:
Dealers are unwilling to invest large amounts in additions as they are required to go out-of-pocket as, for the most part, the aftermarket systems cannot be added to the dealer's floor plan financing.
When dealers do add aftermarket systems to a vehicle prior to sale, they expect a retail margin or Keystone type profit since they are paying cash for these additions.
Many additions will not be recognized for consumer financing and may add no value or, perhaps even worse, diminish value at resale or at the time of trade-in.
There is no guideline or recognized bundled package for consumers to accept that is well designed and branded and is recognized by consumers and dealers at the time of trade-in.
Finally, without using a known methodology, there is no way for a dealer to know what amount to add on which vehicles or in which price ranges.

The reason the aftermarket has the potential to benefit from this issue is its capacity and sophistication in providing quality products to the industry and in many cases meeting or exceeding OEM warranty and quality standards.

When the head of a household goes to purchase a dress coat or suit, it would be unthinkable to make such a purchasing decision without inspecting and first trying on the garment. And yet, a motor vehicle represents a far more significant investment for the family budget. It is critical that the motor vehicle that is to be purchased be available to prospective customers (a) for inspection, and (b) for a test drive at the dealers' site.

It is the object of this invention to have the dealers' inventory of motor vehicles more adequately reflect current household income ranges for the customer base that they service.

It is another object of the invention to have actual sales increase to match potential sales for a dealership for both new and used motor vehicles within the dealer's target area of customers, complete with aftermarket accessories.

It is another object of the invention to optimize market potential for a dealer and maximize dealer profit per vehicle, providing the each targeted customer with as much motor vehicle with aftermarket accessories as said target customer can reasonably afford.

It is yet another object of the present invention to increase each participating dealers' share of aftermarket accessories sold to a customer, making said accessories available to the customer when the new car is purchased.

These and other objects of the invention will be apparent to one of ordinary skill in the art after reading the disclosure of the invention.

What is needed is a motor vehicle dealer analysis marketing system and method that makes optimum use of the space in the dealers' showroom and lot, so that when prospective customers are shopping for a motor vehicle, the type of motor vehicle that the prospective customer is most likely to buy based upon demographic income data is apt to be on site for the prospective customer to inspect and test drive.

### SUMMARY OF THE INVENTION

The present invention addresses these objects and meets these needs.

“Motor vehicles” as used herein includes a broad range of vehicles that are “a self-propelled wheeled conveyance, such as a car or truck that does not run on rails.” Such vehicles include automobiles, cars, SUV's, vans, and light trucks. While the invention as disclosed herein applies to all motor vehicles, for purposes of illustration, much of the disclosure is directed at automobiles.

The method and system are used for marketing new and used motor vehicles for a dealer site for sale or lease to dealer customers. Initially a target area proximate to the dealer site is identified. The target area may be determined by reviewing the dealer's existing customer base to see the distance that the customers are located from the dealer site. The target area may also be determined by using a predetermined distance from the dealer site, an example might be a thirty minute drive time. This could be much larger in some instances or the trade area may have other geographical boundaries, such as rivers, lakes, oceans, bridges, mountains, states, provinces, or foreign countries, or consumer market perceptions. In the absence of existing sales data a Vehicle Origin Survey (VOS) may be performed at key retail sites such as malls, big box retailers and restaurants to determine the actual retail trade area and merchandising characteristics. In some cases it may be necessary to perform this survey even with existing sales data as the dealer may be missing sales from poor selection. A targeted customer base may also be selected within the target area.

Once the size of the target area is determined, demographic data is used to determine the income ranges of household incomes for the overall population residing within the target area. In one preferred embodiment of the motor vehicle dealer analysis marketing system and method of the present invention, the range of household incomes is weighted based upon concentrations of existing customers residing within specific communities of the targeted area. In another preferred embodiment of the motor vehicle dealer analysis marketing system and method with aftermarket accessories of the present invention. The income ranges are weighted for the overall population with priority given to communities in closer proximity to the dealer site.

Once this data is known, it is determined the amount that these households allocate for new or used motor vehicles. Then, the dealer is asked to identify the makes and models of new and used motor vehicles that are available to the dealer in these price ranges. The current possible vehicles as determined by each franchise represented by the dealer can be matched directly with the system and process to provide simplified selection from the dealer matching the merchandising characteristics as defined by the same system and process. Once the size of the dealer's display space are evaluated, a recommendation is made advising the dealer of the appropriate blend of price ranges of new and used motor vehicles to market for sale or lease based upon income ranges of prospective customers within the target area based upon the demographic data. Also, new and used cars with aftermarket accessories are included in the mix.

A significant market exists for vehicle specific products (i.e. replacement parts, aftermarket parts, and vehicle accessories) for cars and other vehicles. The profits that can be generated for after-market parts over the life of a vehicle often exceed the profits that can be realized by the OEM selling the vehicle. Aftermarket accessories for any particular vehicle can be predicted with some degree of certainty based upon the demographic data of the target population.

The reason that the aftermarket has been incorporated into the motor vehicle dealer analysis marketing system and method is due to the dynamic nature of income ranges. The income ranges are dynamic over time and will cause many dealers to change marketing strategies over the next five years. The income ranges are dynamic to each trade area causing unique applications of the system to address their market characteristics. This dynamic nature makes it difficult for OEM's to address this on their own even while improvements made by employing the same system at the corporate level.

For a more complete understanding of the motor vehicle dealer analysis marketing system and method with aftermarket accessories of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 is a comparative bar chart depicting the age demographics of the U.S. census curve and the age demographics of Fiat owners.

FIG. 2 is a bar chart depicting the motor vehicle dealer analysis marketing system and method with aftermarket accessories of the present invention as applied to an actual motor vehicle dealer, the bar chart showing comparative income ranges and new motor vehicles prices ranges for the targeted customers can afford, the bar chart depicting market potential for this target market compared with actual sales.

FIG. 3 is a stock analysis for the dealership of FIG. 2 further using analysis of the motor vehicle dealer analysis marketing system and method with aftermarket accessories of the present invention, again showing the same price range of vehicles as FIG. 2, and analyzing dealer inventory based upon stocking days.

FIG. 4 is an inventory comparison for the dealership of FIG. 2 further using analysis of the motor vehicle dealer analysis marketing system and method with aftermarket accessories the present invention, showing how increasing the inventory of motor vehicles in the higher ranges will impact motor vehicle sales in adjacent ranges.

FIG. 5 is a detailed income profile with a five year projection for the dealership of FIG. 2 further using analysis of the motor vehicle dealer analysis marketing system and method with aftermarket accessories of the present invention, the profile being compiled using demographic data that is readily available.

FIG. 6 is a detailed automotive aftermarket expenditure profile with a five year projection for the dealership of FIG. 2 further using analysis of the motor vehicle dealer analysis marketing system and method with aftermarket accessories of the present invention, the profile being compiled using demographic data that is readily available.

FIG. 7 is a store merchandising example based upon income range as it relates to motor vehicle value for the dealership of FIG. 2 further using analysis of the motor vehicle dealer analysis marketing system and method with aftermarket accessories of the present invention, the profile being compiled using demographic data that is readily available.

FIG. 8 is a simplified store example deploying the motor vehicle dealer analysis marketing system and method with aftermarket accessories of the present invention, depicting an example as to how the display space may best be used.

FIG. 9 is a simplified new car lot store example using the motor vehicle dealer analysis marketing system and method with aftermarket accessories of the present invention for the dealership shown in FIG. 8, depicting an example as to how the display space may best be used.

FIG. 10 is another simplified distribution as to area for new and used motor vehicles using the motor vehicle dealer analysis marketing system and method with aftermarket accessories of the present invention along with retail architect notes.

FIG. 11 discloses a modified bar chart of FIG. 2, with a positive plan to achieve the market potential for this dealership using the motor vehicle dealer analysis marketing system and method with aftermarket accessories of the present invention, by displaying makes and models of price ranges of motor vehicles available to said dealer to sell or lease to each targeted customer as much motor vehicle as each targeted customer can reasonably afford, thereby seeking to maximize dealer profit per vehicle.

FIG. 12 discloses the modified marketing strategy for the dealer of FIG. 11 to achieve his market potential using the motor vehicle dealer analysis marketing system and method with aftermarket accessories of the present invention.

FIG. 13 discloses the modified marketing strategy for the dealer of FIG. 11 to achieve his market potential using the motor vehicle dealer analysis marketing system and method with aftermarket accessories of the present invention, if the dealer decides not to market any motor vehicles over $27,000.

FIG. 14 depicts another simplified bar chart of the motor vehicle dealer analysis marketing system and method with aftermarket accessories of the present invention as applied to an actual motor vehicle dealer, showing potential sales on the same axis for household income distribution ranges for an automotive dealer as compared with market capture rate for that automotive dealer using the motor vehicle dealer analysis marketing system and method with aftermarket accessories of the present invention, both charts being shown on the same axes for purposes of comparison to compare “Actual Sales” with “Potential Sales”.

FIG. 15 is another simplified bar chart depicting potential sales on the same axis for household income distribution ranges for an automotive dealer similar to FIG. 14, where it can be seen by limiting the vehicles that would be of interest to household incomes of $45K to 49.9K, dramatically improved sales of more expensive vehicles, again both chart being shown on the same axes for household income distribution ranges for purposes of comparison to compare “Actual Sales” with “Potential Sales”.

FIG. 16 is yet another simplified bar chart depicting potential sales on the same axis for household income distribution ranges for an automotive dealer similar to FIG. 14, as vehicle selection is improved by providing a broader selection of vehicles to serve all income ranges the total market capture and subsequently total sales increases.

FIG. 17 discloses the vehicle ranges that correspond to households in the trade area. This comparison is at Manufacturer Suggested Retail Price (MSRP) and does not reflect the actual sale price which may be higher due to upgrades and pricing policies or less based on incentives and dealer contributions. The system is capable of refinement for additional accuracy from information in the Dealer's Management System (DMS).

FIG. 18 discloses a simplified analysis of many markets across the United States that have been documented the dynamic nature of income analysis. Incomes are not only unique in each market they are also dynamic over time causing a re-merchandising of the dealership over the next 5 years.

FIG. 19 depicts a bar chart showing the decline from 2000 to 2012, with 2011 and 2012 being forecast, of the decline of dealerships' share of automotive aftermarket.

FIG. 20 discloses a summary of the profit derived from three areas, kit profit, profit from vehicle sales at MSRP and the monetization of labor to install the kit if the dealer decides to participate in this program. Also, the system provides estimates for incremental sales in a new income range, adjacent income range influence, and finally overall market capture influence.

FIG. 21 depicts a Jeep® vehicle with aftermarket equipment package using the teachings of the motor vehicle dealer analysis marketing system and method with aftermarket accessories of the present invention.

FIG. 22 depicts a Dodge Challenger® convertible with aftermarket equipment using the teachings of the motor vehicle dealer analysis marketing system and method with aftermarket accessories of the present invention depicting the size of the aftermarket for the Dodge Challenger®.

### DETAILED DESCRIPTION OF THE INVENTION

After mapping sales data of twenty (20) different retail auto dealerships, it has been determined that:

(1) In all cases income ranges are directly proportional to estimated potential sales for that specific dealership.

(2) Adjacent income ranges are dramatically affected by the lack of motor vehicles available.

(3) As motor vehicle selection is improved by providing a broader selection of motor vehicles to serve each income range, the total market capture and subsequently total sales increases.

(4) By applying the current market capture factors of any dealer or a group of dealers the calculations demonstrate potential sales for motor vehicles in other income ranges.

Transportation is the second biggest allotment of the typical family's budget (shelter being the first). Most budget calculators recommend between 12% and 20% being budgeted for transportation, with 18% being about average. This includes motor vehicle payments as well as gasoline, maintenance and public transportation.

As determined by the trade area analysis of historical sales or vehicle origin surveys from retail actions within the trade area, a customer will select a dealer within that trade area, so that the customer has access to the dealer to service the motor vehicle.

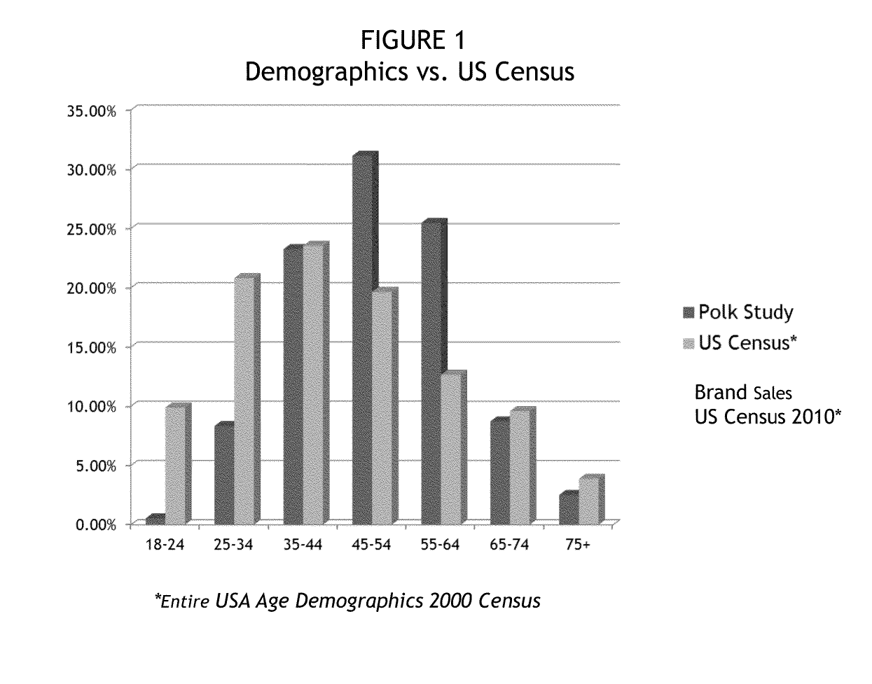

Referring now to the drawings, FIG. 1 is a pair of bar charts depicting the age demographics of the U.S. census curve and a Polk Study of the age demographics of Fiat owners. Notice that the slope of the age curve is nearly identical to the slope of the curve of the Fiat car owners. The 2010 Census confirms this correlation even closer. While trying to define the Fiat customer, what can be seen here is that at least from an age perspective there is no discernable difference from the typical demographic curve for all populations in the U.S. This fact has been verified by most dealers. The important aspect is marketing campaigns and agency buys should not ignore reach in all ages and should avoid broadcast campaigns that focus on a particular demographic attribute. The motor vehicle dealer analysis marketing system and method of the present invention methodology has predicted the same result. When it comes to marketing and sales, sell to everyone.

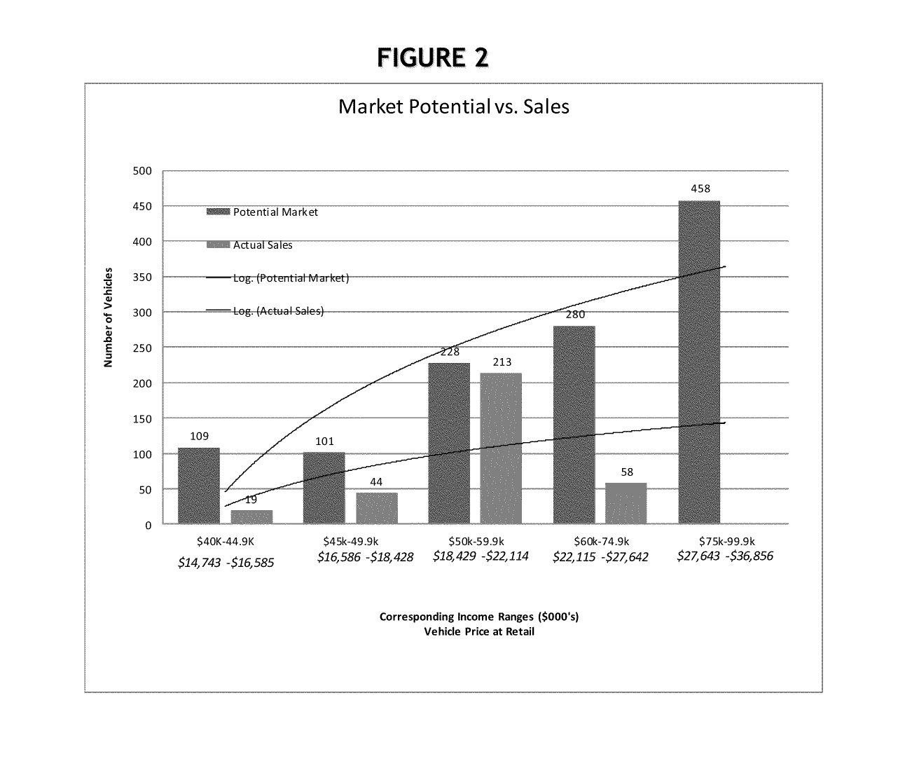

FIG. 2 is a bar chart depicting the motor vehicle dealer analysis marketing system and method with aftermarket accessories of the present invention as applied to an actual motor vehicle dealer. The bar chart shows comparative income ranges and motor vehicles prices ranges for the targeted customers can afford, the darker bars indicating market potential and the lighter bars indicating actual sales.

The merchandising curve represented by the actual market after geo coding sales that occurred through Oct. 31, 2011. In an optimized merchandising scheme, vehicle selection closely approximates the market of the total vehicle sales potential of 1175 vehicles. With the peak occurring in the value range ($18,429-$22,114), there is only an accounting for 1% of the total market represented in the trade area. Note that the adjacent vehicle ranges are greatly affected by lack of selection.

It is projected that the addition of vehicles in the range of $27,000 and greater will greatly improve the sales in the adjacent value range of $22,115$27,642. The addition of vehicles of $16K and less will also help overall market capture which could easily double.

For this particular dealer, the eighty percent trade area boundary is roughly twenty minutes to the northwest, twenty-five minutes east and thirty minutes south of the dealership, the dealership being bordered on the west by the Pacific Ocean. Marketing outside of this trade area will have limited effect.

Also, fewer sales are occurring outside of block groups with average income in the target range that corresponds to motor vehicle selection of household Income between $42K and $75K. In addition, it is noted that sales are not occurring in the higher concentration of households with income of $125K and greater.

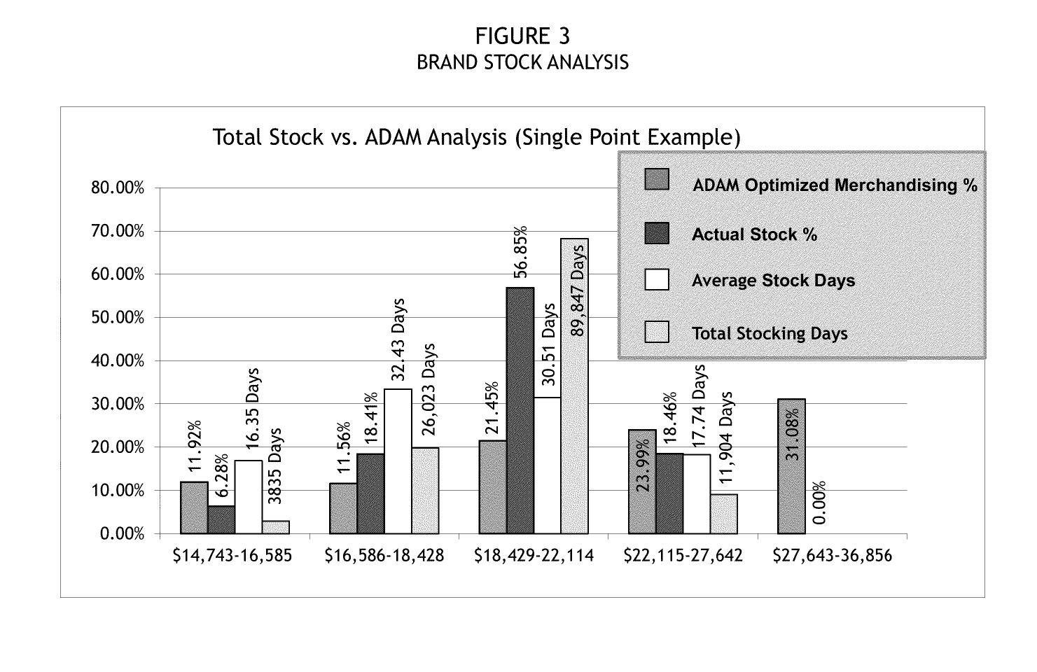

In FIG. 3 the highest percentage of overstocked vehicles occurs in the price range of $18,429 to $22,114. Subsequently, vehicles in this range are in stock an average of 30.51 days and account for greater than three times the number of total stocking days.

This confirms the analysis using the motor vehicle dealer analysis marketing system and method with aftermarket accessories of the present invention of appropriate vehicle mix based on pricing as determined by the income attributes of the specific trade area. This analysis is dynamic for each market and can only be beneficial for manufacturing and planning once all trade areas have been determined and the data is collected in a common report. This data is also dynamic over time and can be predicted five years in advance with a high degree of accuracy.

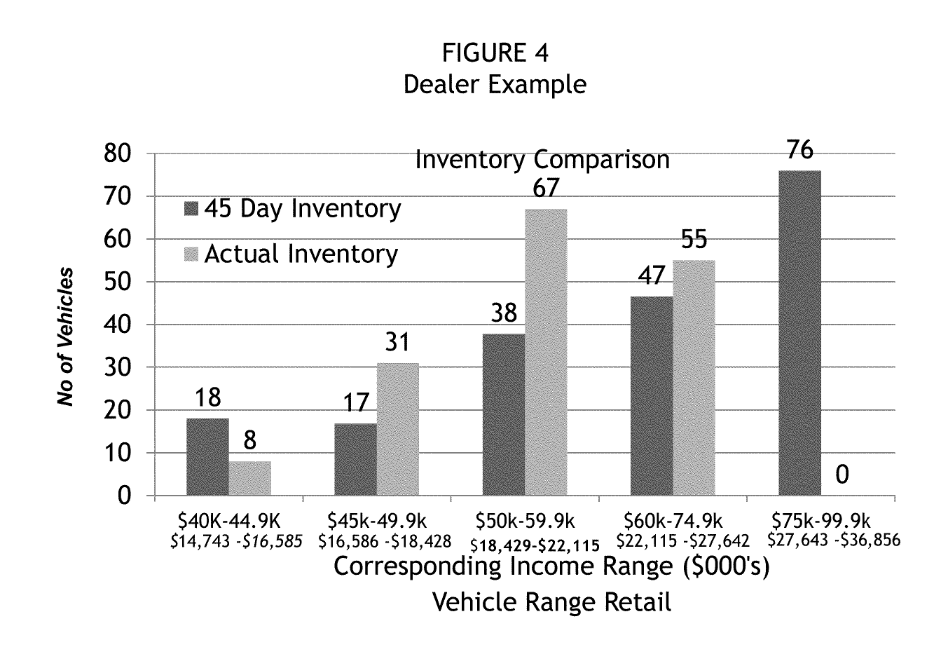

FIG. 4 is an inventory comparison for the dealership. In this specific example, vehicles that are selling more slowly are in vehicle values between $18,429 and $22,115. By shifting some focus and space to additional lower priced motor vehicles under $16,000 this will improve the overall market capture. If space were not a consideration, the inventory of mid-range vehicles would begin to match the optimized merchandising curve. The upward trend continues into the next vehicle ranges above $36,856 and can only be addressed by merchandising vehicles in the adjacent income ranges with corresponding vehicle prices of $27,643 and higher.

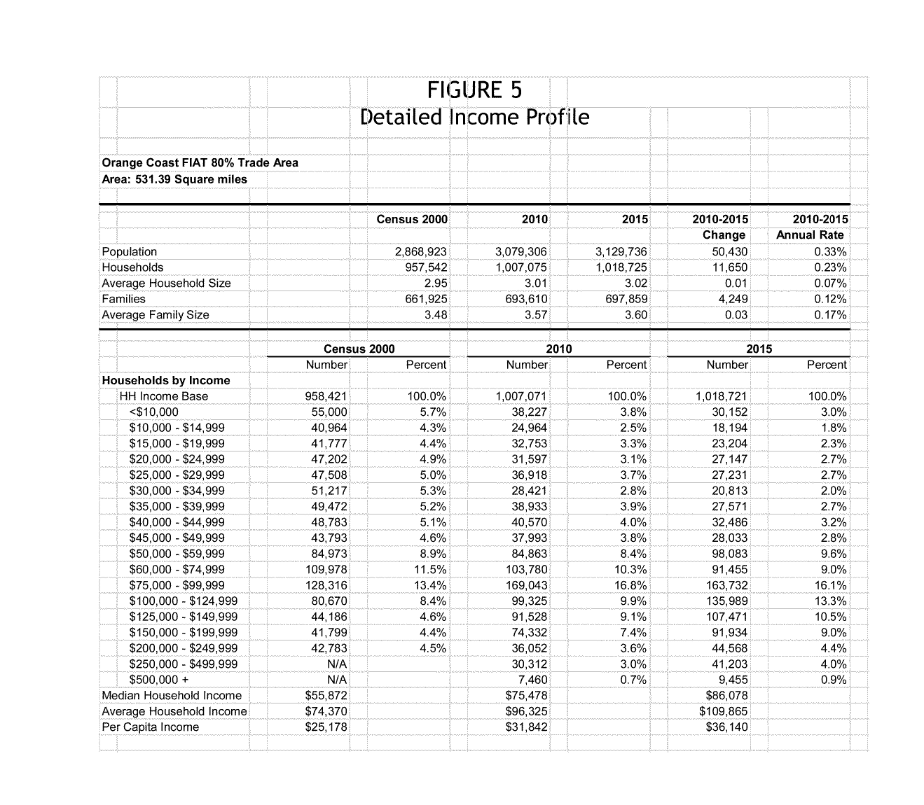

FIG. 5 is a detailed income profile and highlights the dynamic nature of incomes with a five year projection for 2010 to 2015. In household income range less than $50,000 the amount of households or buyers will decrease by as much as 30% while household income above 50% will continue to grow. This is not merely a function of inflation of wages as they will remain relatively flat. This is incomes increasing as the demographics change and incomes increase with age until retirement. Dealership must continue to re-merchandise dynamically over time using analysis techniques of the motor vehicle dealer analysis marketing system and method with aftermarket accessories of the present invention to take advantage of these defined growth areas.

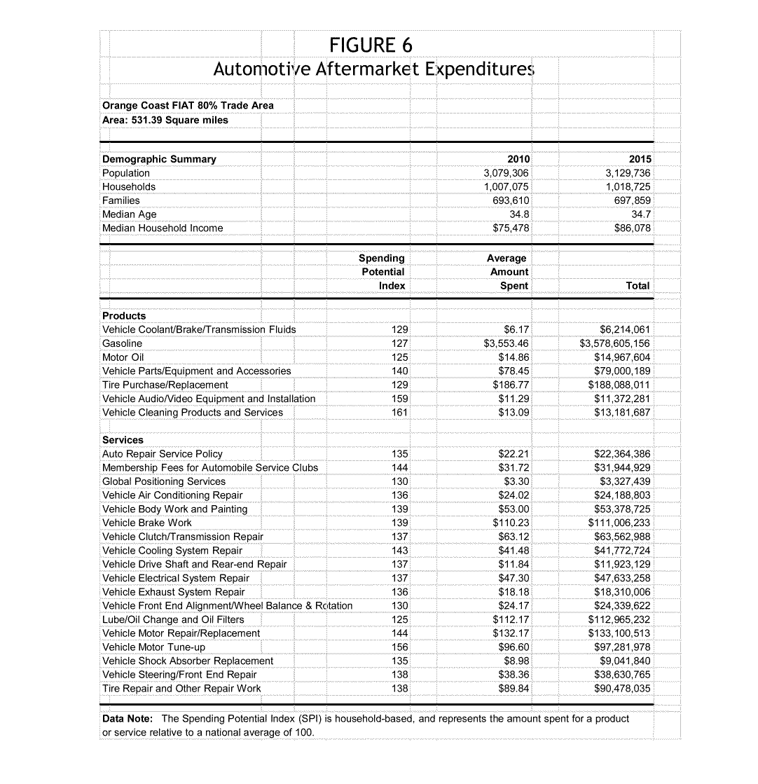

FIG. 6 is a detailed automotive aftermarket expenditure profile with a five year projection for 2010 to 2015. This data is highly accurate and is collected over time from the census and the Bureau of Economic Analysis. Each category is very well defined. In the case of aftermarket accessories this total market is $79,000,000. When a market capture figure of 2% is applied, that equates to $1.6 million per year. An aftermarket strategy of the motor vehicle dealer analysis marketing system and method with aftermarket accessories of the present invention helps capture this retail category as well as applies this to the merchandising of motor vehicles to better match the optimal curve as defined by the income attributes for this specific trade area.

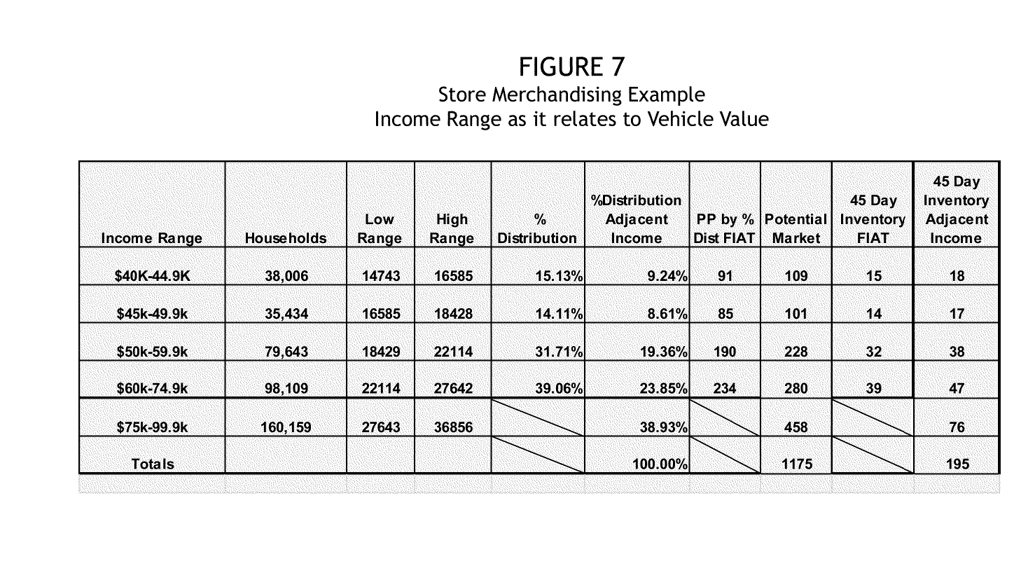

FIG. 7 is a store merchandising example based upon income range as it relates to motor vehicle value for the dealership further highlighting how inventory of motor vehicles impacts sales in adjacent ranges of motor vehicles. Having motor vehicles that match the merchandising curve in the price range of $27,643 to $36,856 will enable better market capture in the household income range and corresponding vehicle price range of $22,114 to 27,642. The total potential sales defined in motor vehicle price range $27,643 and higher of 458 per year will be greatly diminished by not serving the next income range and could be estimated at a factor of 0.33 based on other analysis which equates to 151 vehicles per year in this value range. Since, the growth income ranges are above $50K household income so serving this higher income will be a priority over time.

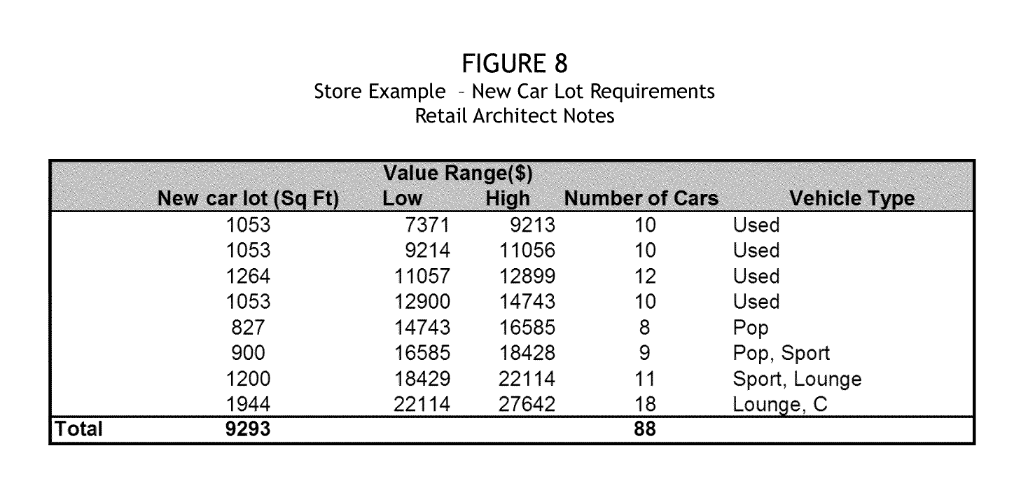

FIG. 8 is a simplified store example deploying the motor vehicle dealer analysis marketing system and method with aftermarket accessories of the present invention, depicting an example of how the display space may best be used for new and used motor vehicles.

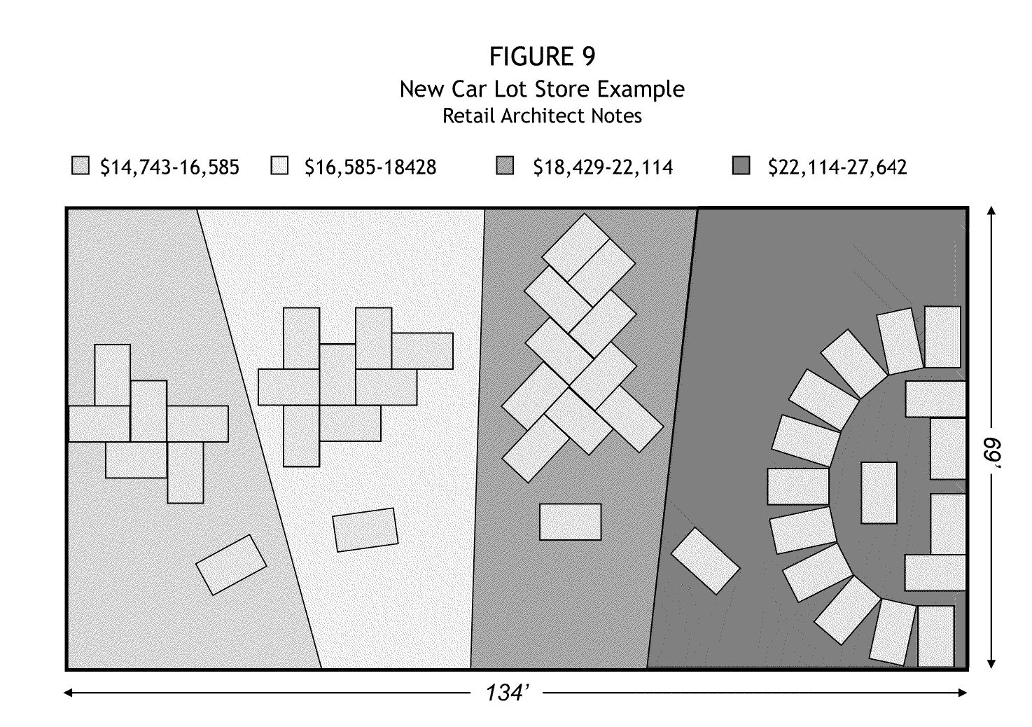

FIG. 9 is a simplified new car lot store example using the motor vehicle dealer analysis marketing system and method with aftermarket accessories of the present invention for the dealership shown in FIG. 8, depicting an example as to how the display space may best be used.

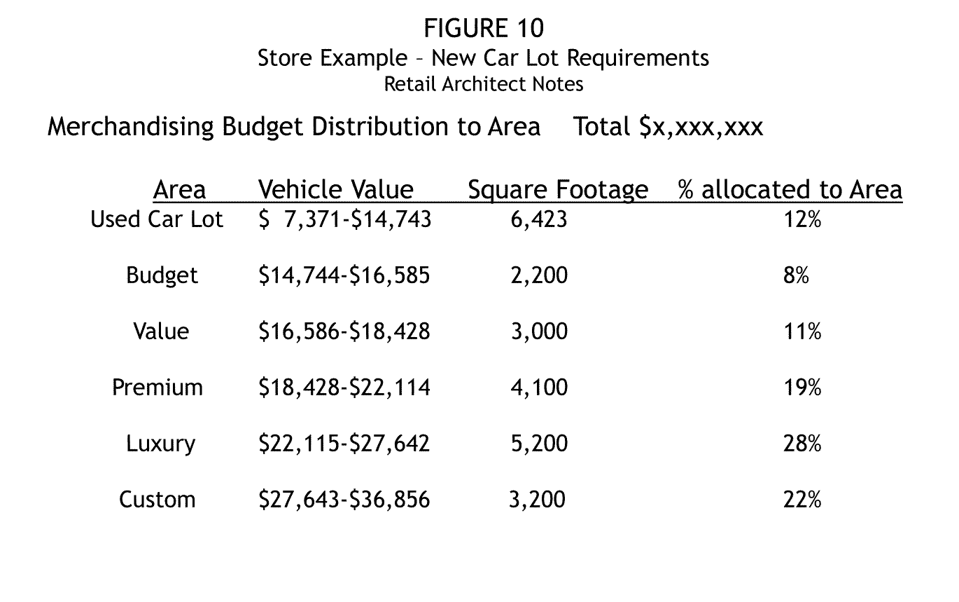

FIG. 10 is another simplified distribution as to area for new and used motor vehicles using the motor vehicle dealer analysis marketing system and method with aftermarket accessories of the present invention along with new car lot requirements, and retail architect notes.

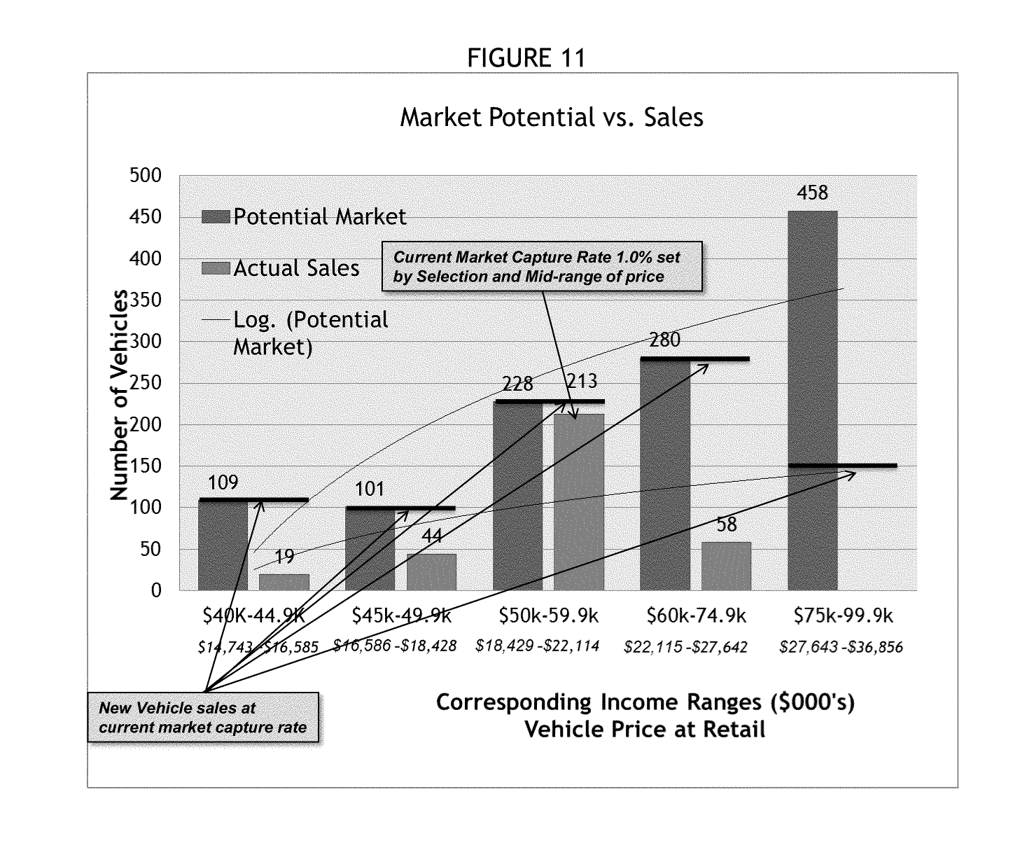

FIG. 11 discloses a modified bar chart of FIG. 2. The upper curve shows the optimal number of vehicles for each class when the next class of motor vehicles is also displayed, since adjacent vehicle ranges will greatly improve the sales of motor vehicles in the next adjacent value range. The lower curve is used to select the number of motor vehicles to display in a range when there are no motor vehicles displayed in the next highest adjacent range.

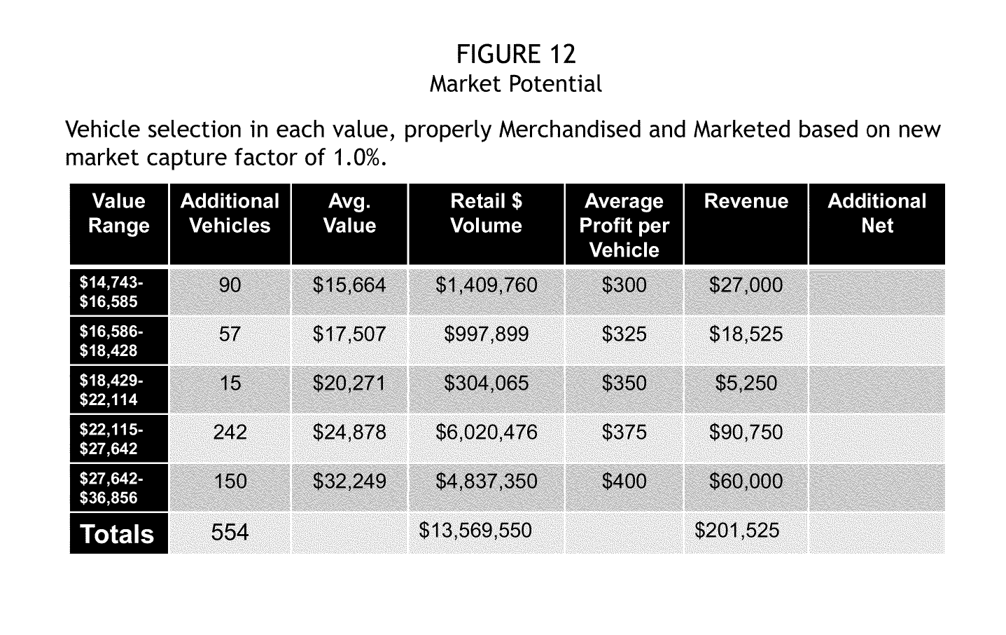

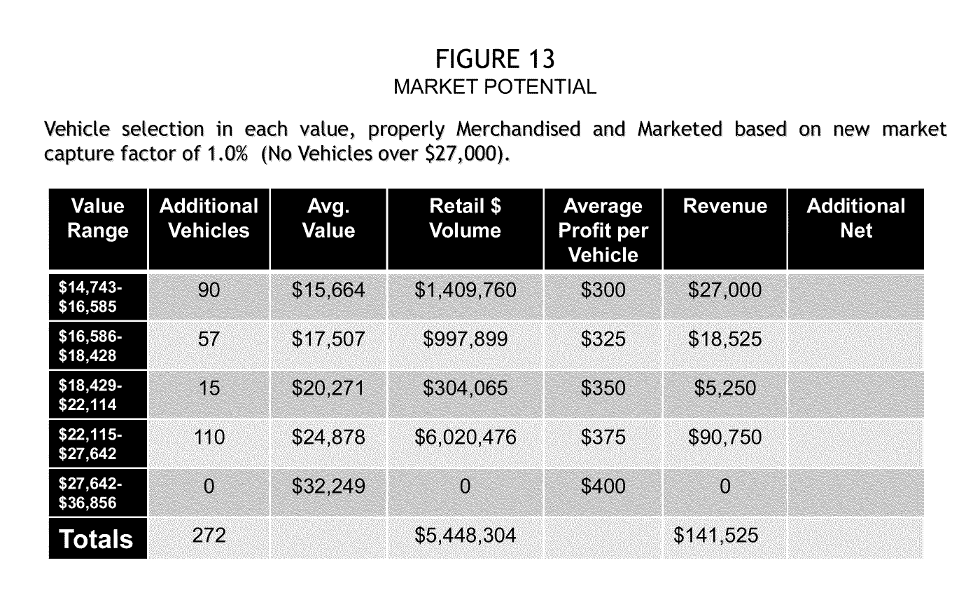

FIG. 12 discloses the modified marketing strategy for the dealer of FIG. 11 to achieve his market potential using the motor vehicle dealer analysis marketing system and method with aftermarket accessories of the present invention, and FIG. 13 discloses the modified marketing strategy for the dealer of FIG. 11 to achieve his market potential using the motor vehicle dealer analysis marketing system and method with aftermarket accessories of the present invention, if the dealer decides not to market any motor vehicles over $27,000.

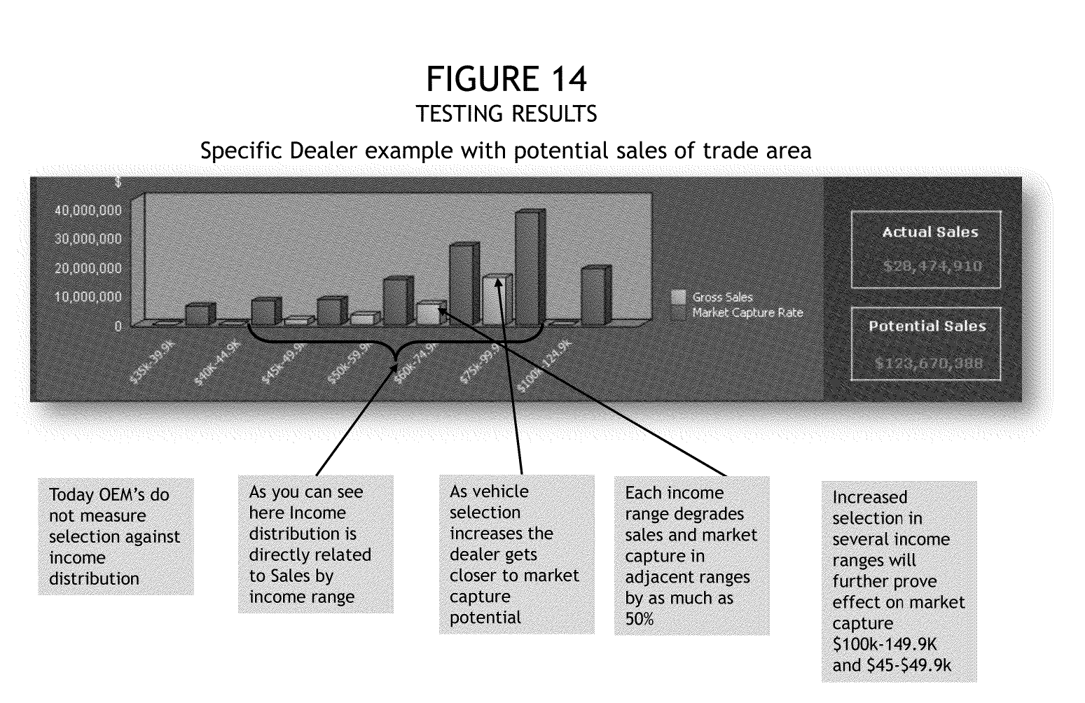

FIG. 14 depicts another simplified bar chart of the motor vehicle dealer analysis marketing system and method with aftermarket accessories of the present invention as applied to an actual motor vehicle dealer, showing potential sales on the same axis for household income distribution ranges for an automotive dealer as compared with market capture rate for that automotive dealer using the motor vehicle dealer analysis marketing system and method with aftermarket accessories of the present invention. Both charts are shown on the same axes for purposes of comparison to compare “Actual Sales” with “Potential Sales”.

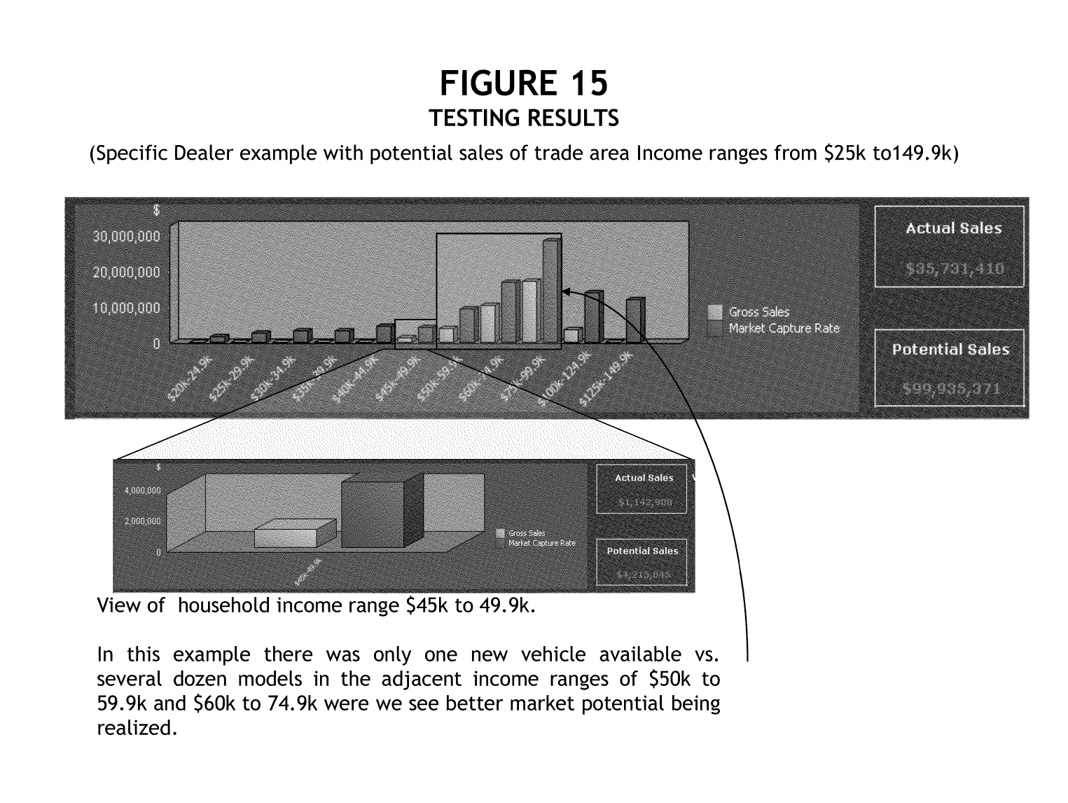

FIG. 15 is another simplified bar chart depicting potential sales on the same axis for household income distribution ranges for an automotive dealer similar to FIG. 14. It can be seen by limiting the vehicles that would be of interest to household incomes of $45K to 49.9K, dramatically improved sales of more expensive vehicles. Again both charts are shown on the same axes for household income distribution ranges for purposes of comparison to compare “Actual Sales” with “Potential Sales”.

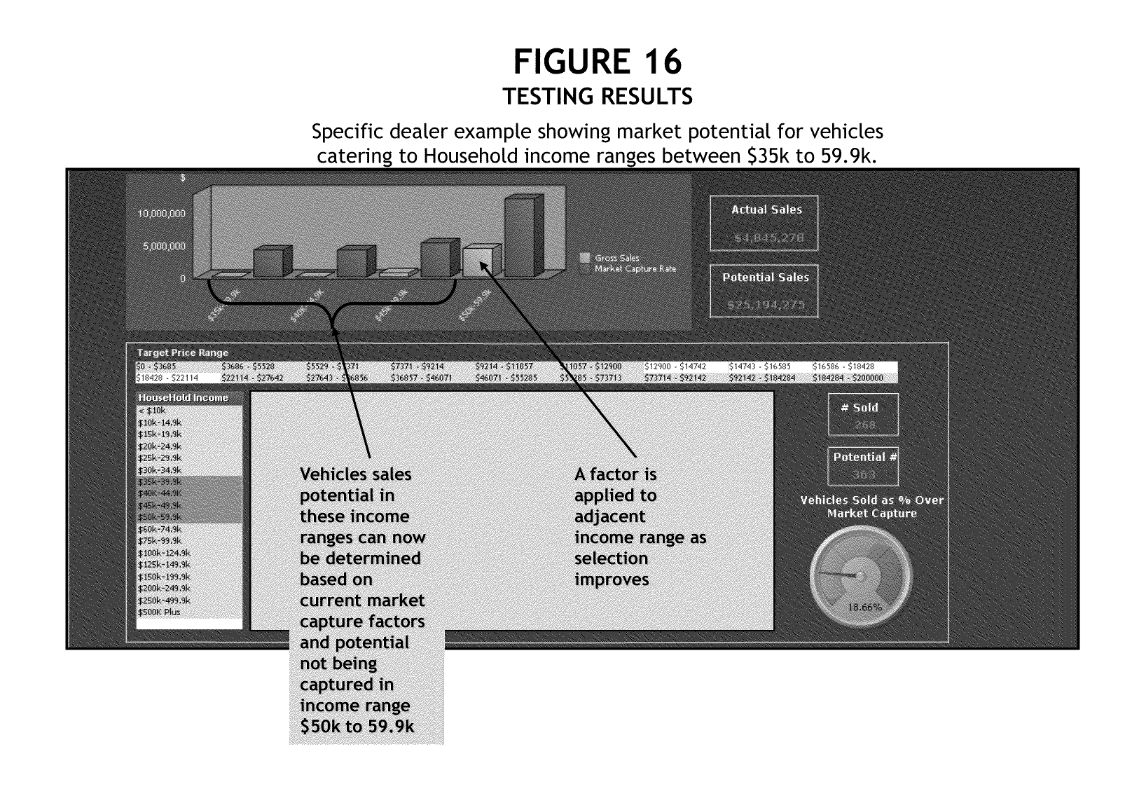

FIG. 16 is yet another simplified bar chart depicting potential sales on the same axis for household income distribution ranges for an automotive dealer similar to FIG. 14, as vehicle selection is improved by providing a broader selection of vehicles to serve all income ranges the total market capture and subsequently total sales increases.

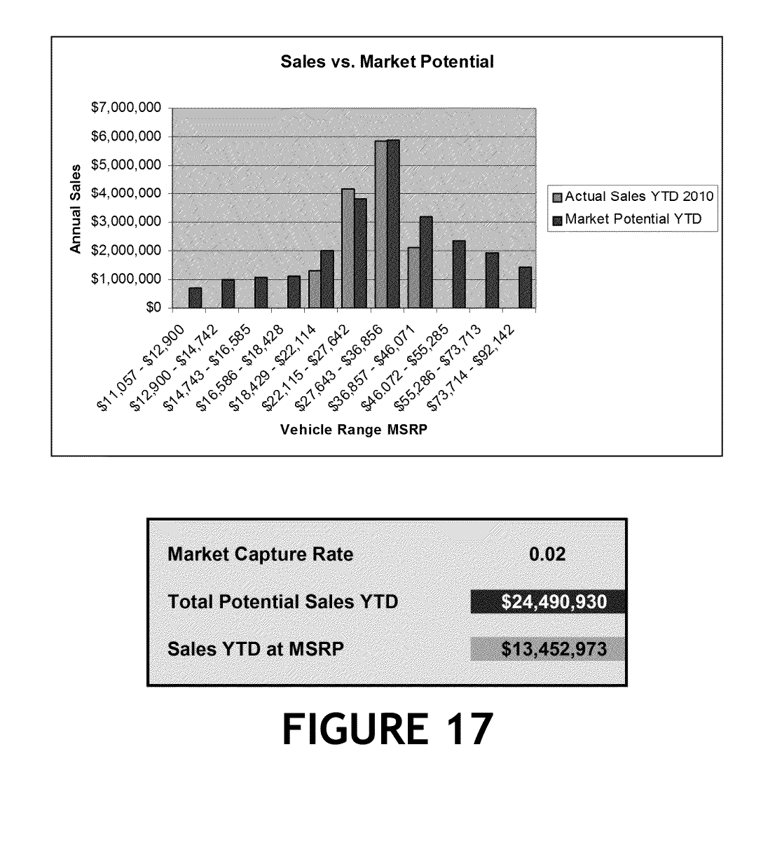

FIG. 17 discloses the vehicle ranges that correspond to households in the trade area. This comparison is at Manufacturer Suggested Retail Price and does not reflect the actual sale price which may be higher due to upgrades and pricing policies or less based on incentives and dealer contributions. The motor vehicle dealer analysis marketing system and method with aftermarket accessories of the present invention is capable of refinement for additional accuracy from information in the Dealer's Management System.

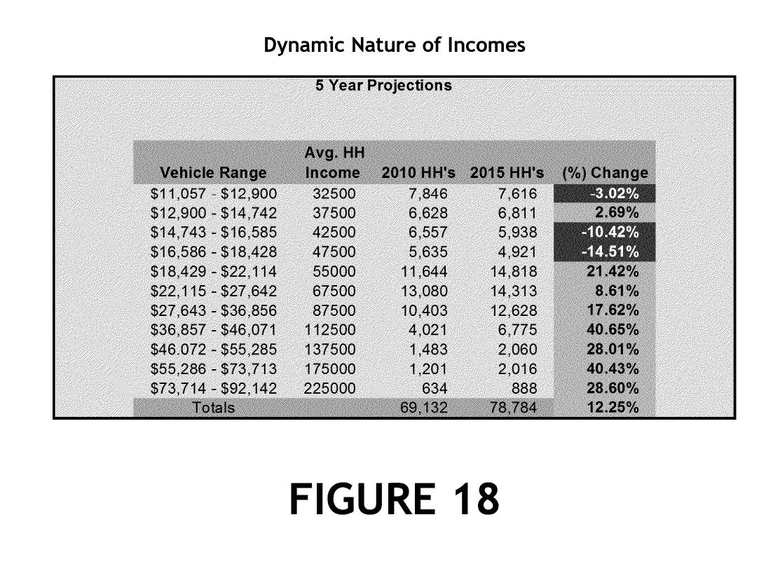

FIG. 18 discloses a simplified analysis of many markets across the U.S. that have been documented the dynamic nature of income analysis. Incomes are not only unique in each market they are also dynamic over time causing a re-merchandising of the dealership every five years.

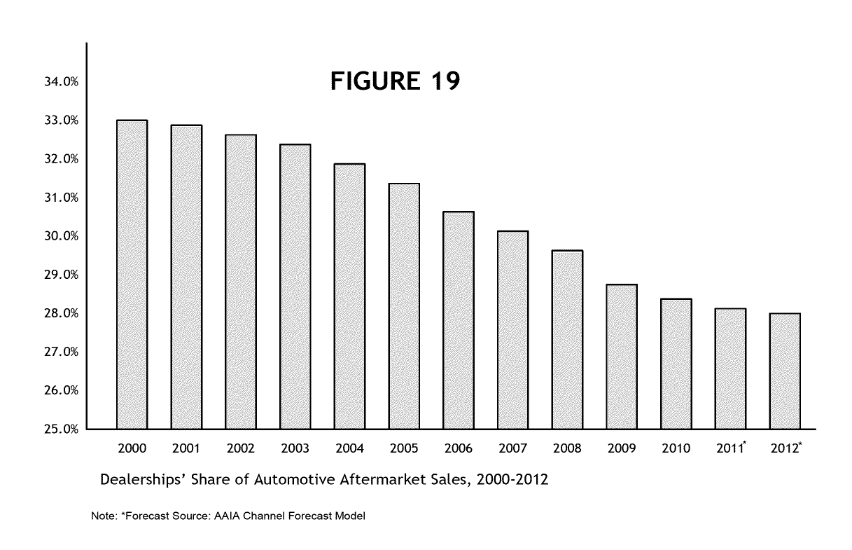

FIG. 19 depicts a bar chart showing the decline from 2000 to 2012, with 2011 and 2012 being forecast of the decline of dealerships' share of automotive aftermarket, the chart being prepared from data supplied by the Automotive Aftermarket Industry Association.

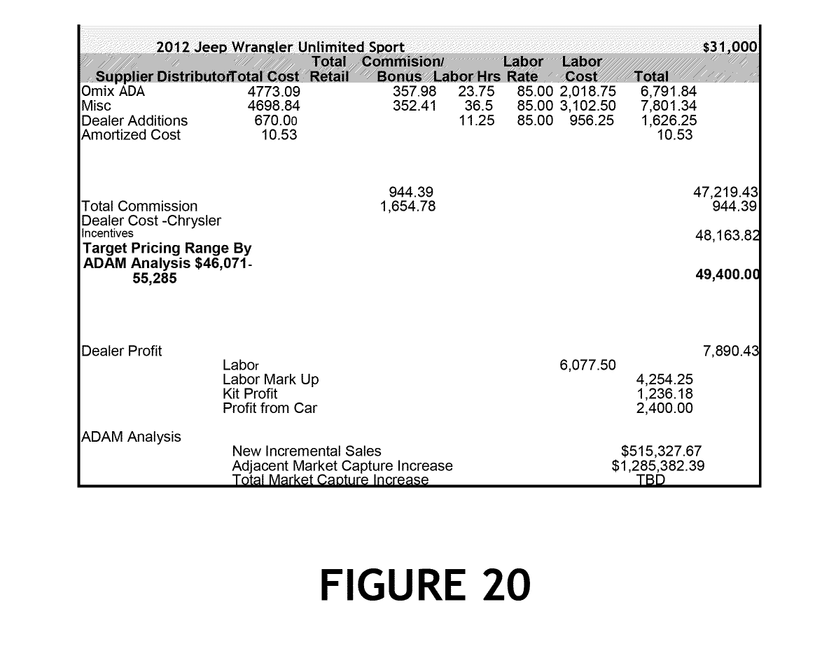

FIG. 20 discloses a summary of the profit derived from three areas, kit profit, profit from motor vehicle sales at the manufacturers suggested retail price and the monetization of labor to install the kit if the dealer decides to participate in this program. Also, the system provides estimates for incremental sales in a new income range, adjacent income range influence, and finally overall market capture influence.

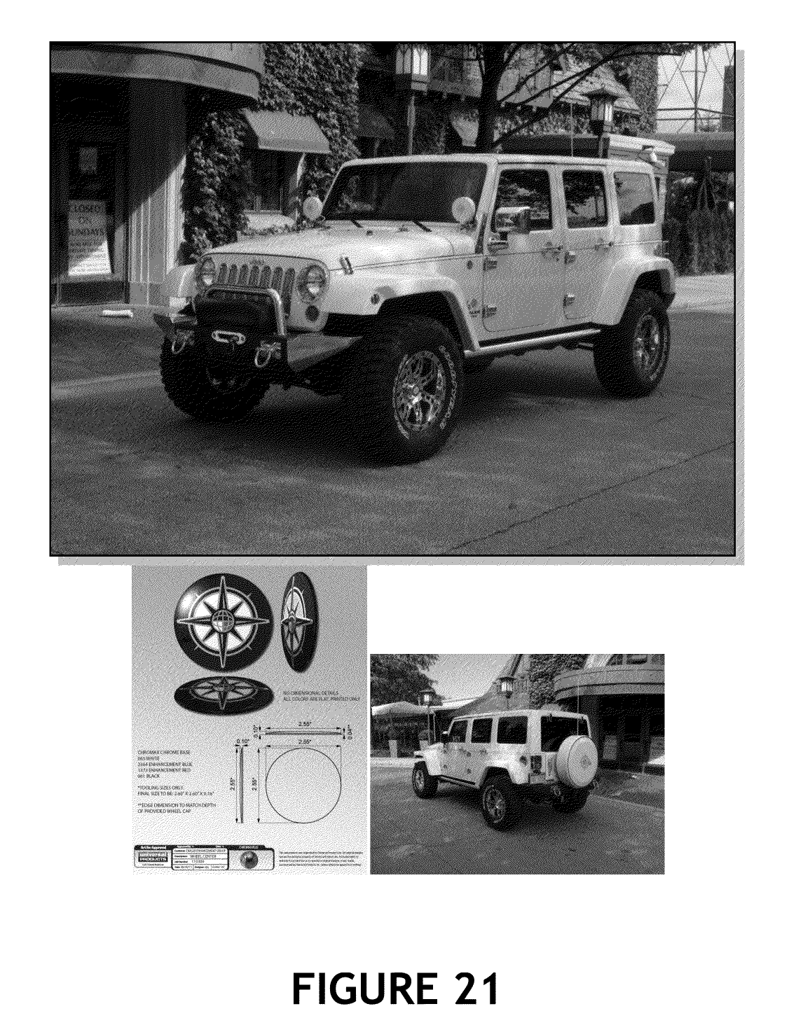

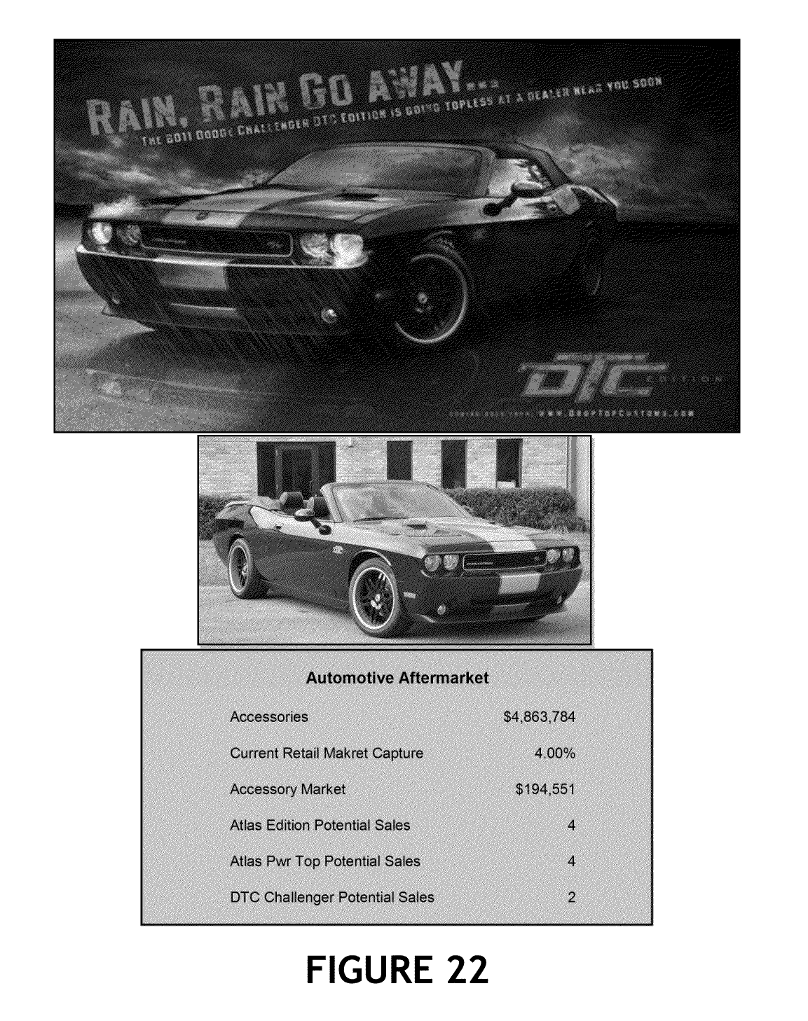

FIG. 21 depicts a Jeep® vehicle with aftermarket trim package using the teachings of the motor vehicle dealer analysis marketing system and method with aftermarket accessories of the present invention; and FIG. 22 depicts a Dodge Challenger® convertible with aftermarket equipment using the teachings of the motor vehicle dealer analysis marketing system and method with aftermarket accessories of the present invention depicting the size of the aftermarket for the Dodge Challenger®.

Aftermarket accessory packages need to be targeted to specific markets within the target area.

If the dealer is marketing motor vehicles to a customer base that will be spending considerable time in their motor vehicles commuting, OEM and aftermarket accessory packages that include remote hands-free information such as existing news sources and supported websites, including subscriptions to value-added services including: weather, custom alerts, traffic conditions, personalized news, e-books, personalized audio feeds, and personalized image or video feeds should be high priorities.

If the dealer is marketing motor vehicles to a customer base in the sun-belt, OEM and aftermarket accessory packages that include convertibles (some even hard-top), deluxe sunroofs, and moon-roofs, should be high priorities.

If the dealer is marketing motor vehicles to a customer base with a high percentage of young families, OEM and aftermarket accessory packages that include vans and SUVs equipped with home entertainment media and Internet hook-ups, and systems that provide large quantities of audio-visual content available for entertainment media should be high priorities.

By utilizing historical sales information, area vehicle origin surveys and estimated trade areas, the motor vehicle dealer analysis marketing method of the present invention determines total personal income for that area within defined income ranges. The motor vehicle dealer analysis marketing system and method of the present invention then estimates potential sales in the trade area and appropriate vehicle mix and inventory based upon sales price.

The motor vehicle dealer analysis marketing system and method of the present invention enables a dealer to nearly reach the full market potential and market capture while managing ordering to maintain the appropriate vehicle mix by price. It also enables for remerchandising the motor vehicle dealers' inventory to allow customers the ability to select motor vehicles based upon their potential spending from their income range. This new vehicle mix can be translated into number of motor vehicles needed in inventory based upon the ability to replenish supply and the square footage needed for space planning. By merchandising the retail operation with these same calculations the retail operation now has guidance on displaying motor vehicles to cater to each potential customer income range.

When tracking individual sales performance for a specific sales person, a dealer is able to determine where the sales people should set up offices to best match his or her comfort with income ranges to serve those income ranges. In time, the factors can be further refined to continue to optimize the dealer's sales performance relative to the market potential determined by the system. The motor vehicle dealer analysis marketing system and method can also recommend marketing remedies for parts of the trade area that are not being served either by inventory of vehicles that match the demographics based upon income range or marketing methods to inform consumers of availability.

The motor vehicle dealer analysis marketing system and method of the present invention is based upon two primary concepts:

Income distribution is directly proportional to purchasing price.

A dealers' market capture of sales potential is diminished when the dealer does not service each income range within that dealers' trade area.

After reviewing motor vehicle dealers' data in multiple locations, both primary concepts have been confirmed as related to motor vehicle marketing.

By utilizing historical sales information, area vehicle origin surveys and estimated trade areas, the motor vehicle dealer analysis marketing method of the present invention determines total personal income for that area within defined income ranges. The process then estimates potential sales in the trade area and appropriate vehicle mix and inventory based upon sales price.

The motor vehicle dealer analysis marketing system and method enables a dealer to nearly reach the full market potential and market capture while managing ordering to maintain the appropriate vehicle mix by price. It also enables for remerchandising the motor vehicle dealers' inventory to allow customers the ability to select motor vehicles based upon their potential spending from their income range. This new vehicle mix can be translated into number of motor vehicles needed in inventory based upon the ability to replenish supply and the square footage needed for space planning. By merchandising the retail operation with these same calculations the retail operation now has guidance on displaying motor vehicles to cater to each potential customer income range.

The dealership location is preferably based upon convenience of existing roads and Infrastructure—how much retail square footage is in the market today. Where roads and access do not exist, developers work with the local units of government to create ramps, bridges, or any other needs to make it easier for potential customers to access. Once all these considerations are addressed space planning and retail merchandising based on the careful science of retail expenditure is married to the artist and design so the customers' experience is natural, which triggers the retail transactions that are going to be made within the dealership.

If the dealership location is a good one, the dealer must select how to sell vehicles. Many dealers believe that a daily grind is needed. This can operate to the detriment of the dealer when the customer experiences buyers' remorse after the sale and shops elsewhere the next time. The only saving grace is that the next experience is no better and the customer eventually returns to shop at the dealership that is most convenient location. The dealer should consider the fact that these sales will actually occur naturally despite their efforts and the retail spend annually on automobile vehicle purchases will be the same for that trade area whether the dealer wakes up, sleeps in, or stands outside in a donkey costume. This track able spend has been very consistent over time and has not fluctuated by 5% over the last 60 years. It is a sobering thought that dealers are only in competition with each other and they chase away more sales then they capture. Not having an inventory that matches the merchandising characteristics of the trade area as defined by the system and process transfers undue pressure on the consumer when the dealer forces the consumer into vehicles that help him reduce the his inventory rather than meeting the needs of the consumers in that area. This is also why dealers lose 80% of sales as potential buyers leave without a purchase not to mention the 98% driving by without stopping in. The industry's own numbers confirm the 2% market captures we have seen in our own analysis.

Throughout this specification, there are various Patent/Applications that are referenced by application number and inventor. The disclosures of these Patents/Applications are hereby incorporated by reference in their entireties into this specification in order to more fully describe the state-of-the-art.

It is evident that many alternatives, modifications, and variations of the present invention and any others disclosed herein of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

1. A system of marketing motor vehicles for a dealer for sale or lease at a dealership site, said system comprising:
a. a dealer data gathering module configured to:
determine a targeted customer base for said dealer, said targeted customer base residing proximate to said dealership site;
determine ranges of household incomes and other demographic data for said targeted customer base; and
determine percentages of said ranges of household incomes of said target customers allocate for motor vehicles;
b. a sales generation module configured to:
identify the makes and models of motor vehicles available to said dealer for sale or lease;
determine OEM option packages attractive to said targeted customer base sold or leased with said makes and models of motor vehicles;
evaluate the size of space available to said dealer for display of said motor vehicles; and
advise said dealer of the appropriate blend of said motor vehicles to display for sale or lease based upon said demographic data of said target population within said target area.

2. The system of claim 1, wherein said appropriate blend of price ranges of motor vehicles includes new motor vehicles, and motor vehicles with aftermarket option packages.

3. The system of claim 2, further comprising wherein the sales generation module determines aftermarket option packages attractive to said targeted customer base sold or leased with said makes and models of motor vehicles for display within said size and space available to said dealer.

4. The system of claim 1, wherein said dealer showroom and lot are configured with said makes and models of price ranges of motor vehicles available to said dealer to sell or lease said target customers as much motor vehicle as said target customers can reasonably afford, thereby seeking to maximize dealer profit per vehicle.

5. The system of claim 1, wherein said dealership site is based upon convenience of existing roads and infrastructure, and the amount of retail square footage available at said dealership site.

6. The system of claim 1, wherein said income ranges of household incomes are weighted based upon concentrations of existing customers residing within specific communities of the targeted area.

7. The system of claim 1, wherein said income ranges of household incomes are weighted for the overall population in closer proximity to said dealership site.

8. The system of claim 1, wherein the data gathering module is dynamic and predicts household incomes five years in advance with a relatively high degree of accuracy.

9. A system of marketing motor vehicles for a dealer for sale or lease at a dealership site, said system comprising:
a. a dealer data gathering module configured to:
generate a target area proximate to said dealership site;
determine income ranges of household incomes for overall population residing within said target area;
determine percentages for said income range of household incomes for said overall population residing within said target area allocate for new or used motor vehicles; and
determine household demographics for said overall population residing within said target area;
b. a sales generation module configured to:
identify makes and models of motor vehicles available to said dealer for sale or lease;
determine OEM options packages commonly purchased with said makes and models of motor vehicles;
evaluate the size of space available to said dealer for display of said motor vehicles; and
advise said dealer of the appropriate blend of price ranges of motor vehicles to display for sale or lease based upon said demographic data of said target population within said target area;
whereby said display space is configured with said makes and models of motor vehicles available to said dealer to sell or lease to each said targeted customer as much motor vehicle as each said targeted customer can reasonably afford, thereby seeking to maximize dealer profit per motor vehicle while providing each said targeted customer with a motor vehicle within budget.

10. The system of claim 9, wherein said appropriate blend of price ranges of motor vehicles includes new motor vehicles, and motor vehicles with aftermarket option packages.

11. The system of claim 10, further comprising wherein the sales generation module determines aftermarket option packages attractive to said targeted customer base sold or leased with said makes and models of motor vehicles for display within said size and space available to said dealer.

12. The system of claim 9, wherein said dealer showroom and lot are configured with said makes and models of price ranges of motor vehicles available to said dealer to sell or lease said target customers as much motor vehicle as said target customers can reasonably afford, thereby seeking to maximize dealer profit per vehicle.

13. The system of claim 9, wherein said dealership site is based upon convenience of existing roads and infrastructure, and the amount of retail square footage available at said dealership site.

14. A method of marketing motor vehicles for a dealer at a dealership site, said method comprising:
a. generating a target area proximate to said dealership site;
b. determining the income ranges of household incomes for the overall population residing within said target area by use of demographic data;
c. determining percentages said overall population residing within said target area allocates for motor vehicles;
d. identifying the makes and models of motor vehicles available to said dealer for sale or lease;
e. evaluating the size of space available to said dealer for display of said motor vehicles; and
f. advising said dealer of the appropriate blend of motor vehicles to market based upon income ranges to said target customers within the target area and based upon pertinent demographic data;
whereby said display space is configured with said makes and models of motor vehicles available to said dealer to sell or lease to each said targeted customer as much motor vehicle as each said targeted customer can reasonably afford, thereby seeking to maximize dealer profit per motor vehicle while providing each said targeted customer with a motor vehicle within budget.

15. The method of claim 14, wherein said appropriate blend of price ranges of motor vehicles includes new motor vehicles, and motor vehicles with aftermarket option packages.

16. The method of claim 15, further comprising wherein the sales generation module determines aftermarket option packages attractive to said targeted customer base sold or leased with said makes and models of motor vehicles for display within said size and space available to said dealer.

17. The method of claim 14, wherein said dealer showroom and lot are configured with said makes and models of price ranges of motor vehicles available to said dealer to sell or lease said target customers as much motor vehicle as said target customers can reasonably afford, thereby seeking to maximize dealer profit per vehicle.

18. The method of claim 14, wherein said dealership site is based upon convenience of existing roads and infrastructure, and the amount of retail square footage available at said dealership site.

19. A method of marketing motor vehicles for a dealer, said method comprising:
a. selecting a dealership site based upon convenience of existing roads and infrastructure;
b. generating a target area proximate to said dealership site;
c. determining the income ranges of household incomes for the overall population residing within said target area by use of demographic data;
d. determining percentages said overall population residing within said target area allocates for motor vehicles;
e. identifying the makes and models of motor vehicles available to said dealer for sale or lease;
f. evaluating the size of space available to said dealer for display of said motor vehicles; and
g. advising said dealer of the appropriate blend of motor vehicles to market based upon income ranges to said target customers within the target area and based upon pertinent demographic data.

20. The method of claim 19, wherein said appropriate blend of price ranges of motor vehicles includes new motor vehicles, and motor vehicles with aftermarket option packages.

21. The method of claim 20, further comprising wherein the sales generation module determines aftermarket option packages attractive to said targeted customer base sold or leased with said makes and models of motor vehicles for display within said size and space available to said dealer.

22. The method of claim 19, wherein said dealer showroom and lot are configured with said makes and models of price ranges of motor vehicles available to said dealer to sell or lease said target customers as much motor vehicle as said target customers can reasonably afford, thereby seeking to maximize dealer profit per vehicle.

23. The method of claim 19, wherein said target area is generated by using a predetermined distance from said dealer site.

24. The method of claim 19, wherein said income ranges of household incomes are weighted based upon concentrations of existing vehicle drivers residing within specific communities of the targeted area.

25. The method of claim 19, wherein said income ranges of household incomes are weighted for the overall population in closer proximity to said dealership site.
